(19) United States
(12) Patent Application Publication
(10) Pub. No.: US 2009/0201436 A1
(43) Pub. Date: Aug. 13, 2009

(54) Display and Control Concealment Method and Apparatus

(76) Inventor: Michael A. Strazzanti, Gates Mills, OH (US)

Correspondence Address: JEANNE E. LONGMUIR, 2836 CORYDON ROAD, CLEVELAND HEIGHTS, OH, 44118, US

(21) Appl. No.: 12/361,534

(22) Filed: Jan. 28, 2009

Related U.S. Application Data
(60) Provisional application No. 61/024,084, filed on Jan. 28, 2008.

(51) Int. Cl. G02F 1/1335

(52) U.S. Cl. 349/16

(57) ABSTRACT

The present invention is a novel masking device to change the appearance of a control or display system in a manner which adds to its aesthetic appearance. Electrically activated or switchable films are incorporated into the control or display allowing the outward appearance to be altered between at least two visual conditions. The area may change in color, pattern, transparency or reflectivity. Such a masking apparatus can be employed where a display or control system is desired to be concealed, camouflaged or altered in its appearance.

### CROSS REFERENCE TO RELATED APPLICATION

This application claims priority from U.S. patent application Ser. No. 61/024,084 filed Jan. 28, 2008, the entire subject matter of which is incorporated herein by reference.

### FIELD OF INVENTION

This invention relates generally to display and control systems, and more particularly to a display and control system concealment method and apparatus for use in connection with a variety of display and control system environments.

### BACKGROUND OF THE INVENTION

Electronic controls and information displays increasingly have an integrated appearance in structures such as walls, vehicle dashboards and appliances, for example. Motor vehicle interiors specifically have increasing amounts of displays, controls, lights and other features which are inhomogeneous in appearance to their surroundings. These systems are found in the dashboard, door, seat, support pillar column, roof and center column. The purposes of these systems may include navigational information displays, window controls, audio system controls, odometer and tachometers, fuel gages, video systems, climate controls, center high mounted stop lamps and interior lighting systems, for example.

Display and control systems can also be found in homes, commercial buildings, airplanes and businesses. In some instances these systems include touch screen panels so that the profile of the control or display is level with the structure it is incorporated into. When these systems are not in use, their appearance is inhomogeneous with the surrounding area. Examples of environments which would benefit from the concealment or of a display or control system may include light switches or other controls installed in a wall, display systems in refrigerator door exteriors, or in-flight entertainment systems on airplanes.

Vehicle systems in particular have increased in number and sophistication at an increased pace in recent years. Such display or control systems are generally installed in the vehicle dashboard so that the vehicle occupants can view the information displayed with minimal distraction. The distractive effect of the presence of the systems on vehicle safety has been studied extensively. One such study is “Driver Distraction and Crashes: An Assessment of Crash Databases and Review of the Literature,” University of Michigan Transportation Research Institute, Report Number UMTRI-2003-12.

In-dashboard displays are sometimes installed with a rotating cover plate which physically conceals the display panel when not in use. Tannas describes in U.S. Patent Application Publication No. 20040263761, the use of filters and films to customize in-vehicle displays without the need for cutting and resealing the original display. Scharenbroch describes in U.S. Patent Application Publication No. 20050179827, information being displayed on an in-dashboard display so that only the non-driving occupants of the vehicle can view the display. Neither of these systems provides an aesthetic system or a masking device for the purpose of camouflaging or concealing the controls or displays.

### SUMMARY OF THE PRESENT INVENTION

The present application provides a novel masking device and method for concealing such controls using electrically activated materials. Examples of such materials may include liquid crystal, dichroic dyes or ion films. In one embodiment of the present application, a liquid crystal is mixed with a polymer and a film is created which is known as polymer stabilized technology or polymer stabilized liquid crystal. Using polymer stabilized technology, a mixture of liquid crystal and polymer are sandwiched between two plastic or glass sheets. The plastic or glass sheets are coated with a transparent conductive material such as indium tin oxide. The resultant film is a switchable film which has an opaque appearance which can be changed to a transparent appearance with the application of electricity. Such films can be constructed so that the presence of electricity creates a transparent appearance, or alternately constructed so the presence of electricity creates an opaque appearance. A switchable film which is opaque in the absence of electricity, and transparent when electricity is applied, is referred to as regular mode. A film which is transparent in the absence of electricity, and opaque when electricity is applied, is referred to as reverse mode.

Such films can also incorporate a dichroic dye which creates a colored opaque appearance, which appearance can likewise be changed to transparent and colorless. Some amount of color may remain in the transparent state depending upon level of dye concentration in the film.

Films may also be constructed of liquid crystal with a dichroic dye and no polymer network. These films appear colored and transparent in the absence of electricity, and colorless and transparent in the presence of electricity. These films can be constructed to operate in regular or reverse mode as described above.

Another type of film which may be used is a film which appears highly reflective in the absence of electricity and highly transparent in the presence of electricity. This reflectivity can be specular in nature, so as to provide a mirror appearance to the surface of the film and system. Such a film is described in U.S. Patent Application Publication No. 20040021921.

### BRIEF DESCRIPTION OF THE DRAWINGS

Shown in the drawings are embodiments which are presently preferred, it being understood, however, that the invention is not limited to the precise arrangements and instrumentalities shown.

FIG. 1A schematically illustrates a control or display system apparatus of the present application where the controls or displays are in reveal condition;

FIG. 1B schematically illustrates the control or display system apparatus of FIG. 1A with the controls or displays in conceal condition;

FIG. 2 schematically illustrates an example of the construction of a switchable film used in the present apparatus which is movable between reveal or display and conceal conditions;

FIG. 3 schematically illustrates the construction of a switchable film of the present apparatus used with a touch panel control or display system;

FIG. 4 schematically illustrates the construction of the switchable film of FIG. 3 of the present apparatus shown mounted within a wall;

FIG. 5 schematically illustrates a display and control system having a single layer switchable film with a pattern meant to mimic the appearance of wood grain;

FIG. 6 schematically illustrates an alternate display and control system provided in exploded view showing a stack of the switchable films which create the appearance of wood grain when the present apparatus is in the conceal condition; and

Drawing 7 schematically illustrates alternate construction of a switchable film of the display and control concealment system having a non-flat surface profile.

### DETAILED DESCRIPTION OF THE PREFERRED EMBODIMENTS

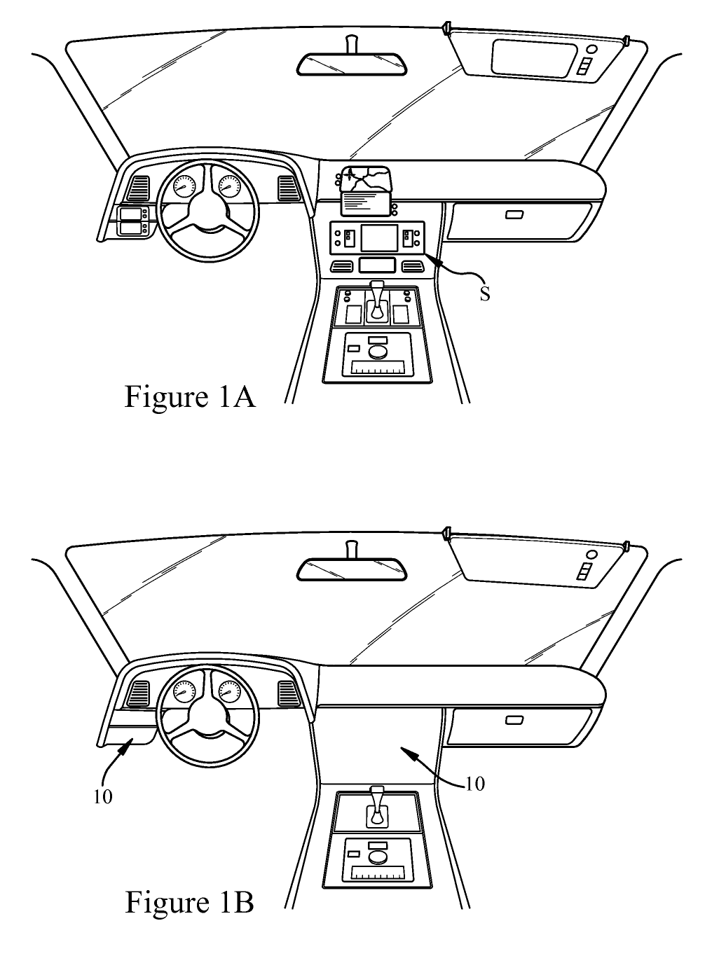

The present application provides a display and control system concealment apparatus 10 and method, wherein various electrically activated films can be used to create novel aesthetic appearances. As shown in FIG. 1A, the masking or concealment apparatus 10 may be used in an area or environment using a display or control system S, such as a vehicle interior, where it is desired that the displays and controls may be viewed as desired by a user.

The masking or concealment apparatus 10 includes a film 12 which may be changed or switched between at least two appearance conditions, where the concealed appearance for masking the displays and controls S is shown in FIG. 1B. The apparatus 10 may be constructed using a dye which matches the color of the surrounding area or environment of a display or control system S. The film 12 is placed over the display S to create a homogenous appearance with the surrounding area when the film 12 is in the colored and opaque state. The film 12 can then be electrically activated so as to become transparent and reveal the display or control system S. It should be understood that the use of prior art liquid crystal masking devices is known in connection with vehicle head lamps, descriptions of which are set forth in U.S. Pat. No. 7,036,966, for example, and the disclosure of which is incorporated herein by reference with respect to the prior art devices.

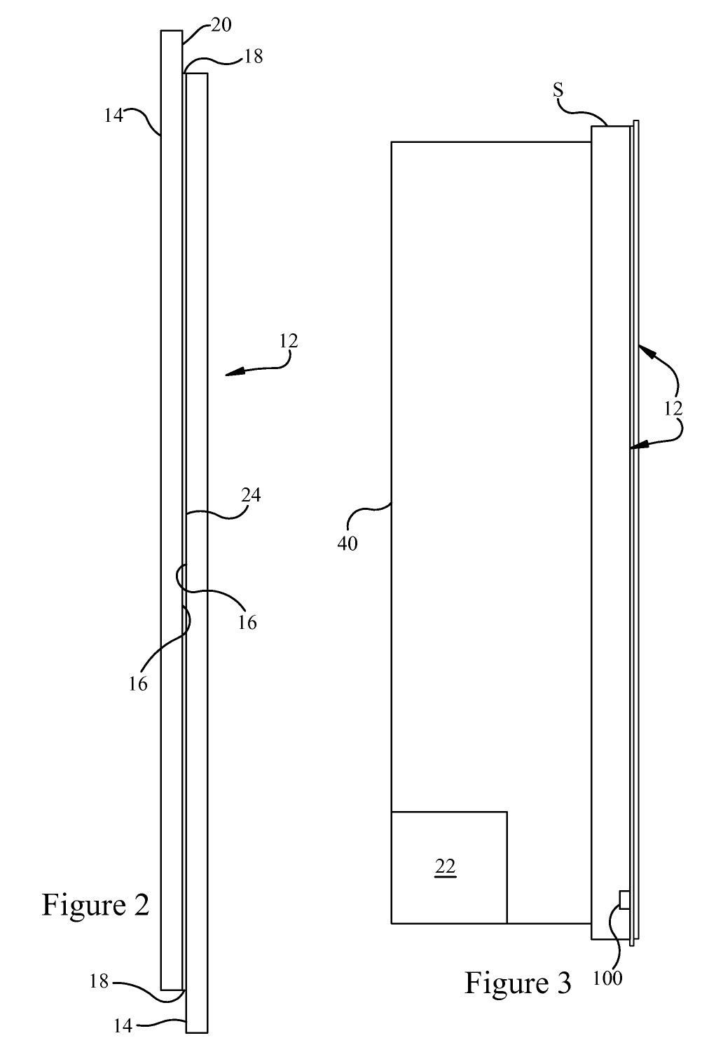

In one embodiment of the present apparatus, as shown in FIG. 2, the switchable film 12 comprises a unit of two sheets of either light transmitting glass or flexible plastic sheets 14. The sheets 14 are coated on opposing, inside facing surfaces with a transparent conductive substance 16, preferably indium tin oxide or ITO. An epoxy material 18 or other sealing material is provided to join the sheets 14. Areas 20 are provided on the film 12 where the transparent conductive substance is electrically connected to the electric drive circuit 22, and are provided on each end of the film 12 to enable a flow of current from a positive side to a negative side. The liquid crystal material 24 provided may be a conventional liquid crystal, dichroic dye and liquid crystal material, a polymer material or a dichroic dye material.

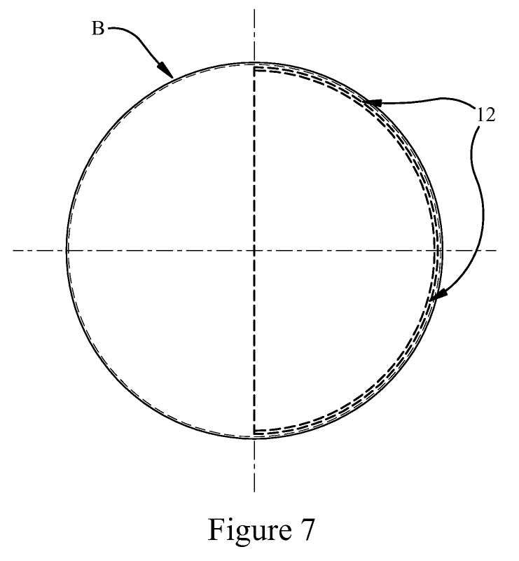

An alternate of a single film 12 embodiment is shown in FIG. 5, where a single film 12 having a polymer stabilized liquid crystal (PSLC) material is constructed with a dichroic dye matching the color of the control or display's surrounding area. This film 12 is placed over the display and in the powered state the control S is visible to a driver as in FIG. 1A. When electricity is applied to the film, the film becomes transparent and colorless revealing the display or controls S. In the FIG. 5 embodiment illustration, the surface of the single film 12 is additionally provided with a pattern which is meant to mimic the appearance of wood grain. A film which mimics the appearance of wood grain is created as a single film 12 by applying a non-conductive polymer in a pattern which matches the outline of the dark wood grain onto the external surface of one of the film's sheets 14. This polymer would be cured and act as a barrier 26 to segregate the polymer stabilized liquid crystal dyed to appear as the dark wood grain from the polymer stabilized liquid crystal dyed to appear as the light wood. The substrate would be joined with the second sheet 14, and the segregated areas of the film would be filled by a vacuum process wherein the polymer, liquid crystal and dichroic dye mixture are all pulled in from one side of a segregated cavity by a vacuum pump applied to the opening on the other end of the cavity. Alternatively, the liquid crystal film 12 could be provided with barrier lines 26 which are applied or etched into the surface of the film 12, so that alternating spacing is produced between two barrier lines. These spaces are filled with alternating mixtures of a dark and light dyed liquid crystal to simulate the dark and light patterns of wood grain.

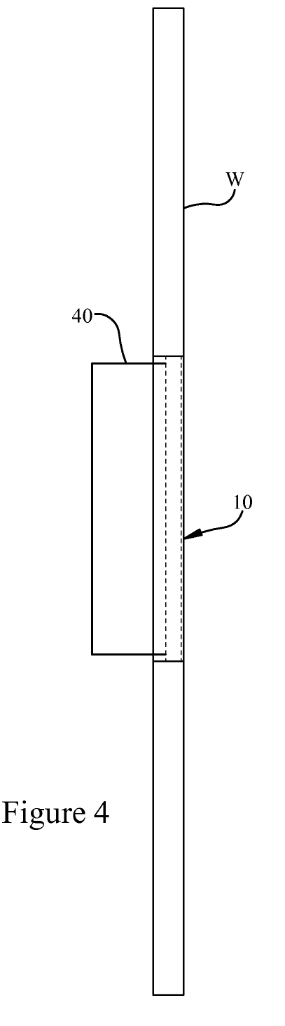

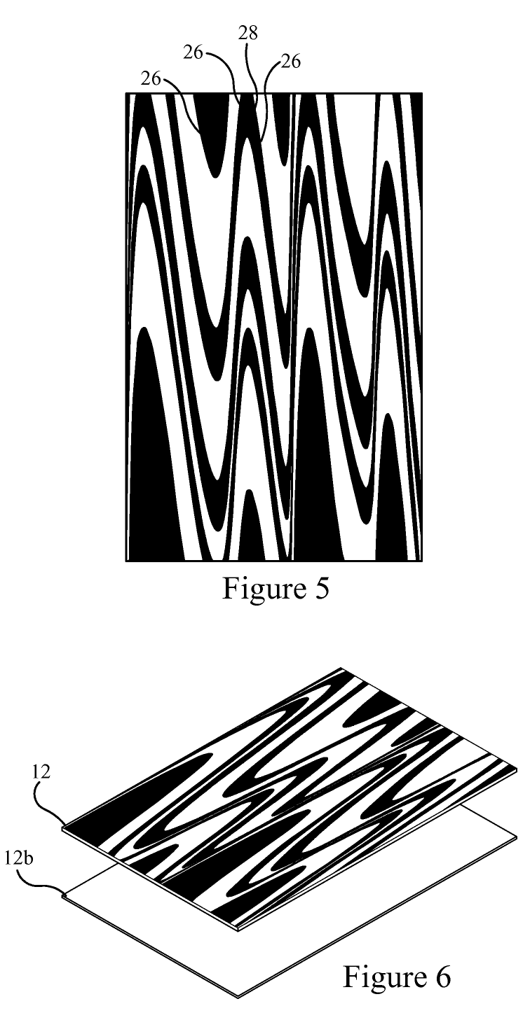

Still further single film embodiments are illustrated in FIGS. 3 and 4. FIG. 3 illustrates a display panel control C or touch panel control for a system S with a concealment film 12 applied over its surface. An electronic housing 40 including the drive circuit 22 for the apparatus 10, supports the touch panel display C.

FIG. 4 provides a still further illustration of the concealment film 12 mounted over a display panel control C, as in FIG. 3, installed into a wall W.

In a multi-film embodiment, multiple films 12 can be used to create a homogenous appearance when the display or control S is installed in a area with multiple surrounding area appearances. For example, in a dashboard of a vehicle it is common for leather, wood and/or metallic trims to be used across the surface. Generally, the upper portion of the dashboard is leather or plastic, below that area is some type of metallic trim and below that some type of wood finish may be used. In this multiple material area, a film 12 is created to match each type of surrounding environment area at the periphery of the display or controls S. The upper portion where the navigation display may be located is covered with a polymer stabilized film 12 dyed to match the color of the leather or plastic.

Such an embodiment is schematically illustrated in FIG. 6, where stacked films 12 are used to mimic the appearance of wood grain. In order to mimic the wood grain several films may be stacked on top of each other to cover the system controls or displays S. The wood grain may exhibit a pattern of a dark grain in a light wood. In this embodiment, a film 12 is provided with the barriers 26 described above, and only the alternating spaces or bands 28 are filled with a dark dyed liquid crystal and the intermediate bands are empty. A second film 12b with a dyed liquid crystal which has the appearance of the light colored portion of a wood grain is provided behind the etched film 12. When the etched film 12 is stacked on top of the light color film 12b the light color shows through the empty bands of the etched film. By stacking the dark grain film 12 on top of the light wood color film 12b the controls and displays would be concealed in a manner which mimics the surrounding wood trim area.

Such films 12, 12b may also have unique surface texturing applied to the outward facing surface of the plastic or glass sheets 14 so as to match the surface texture of the surrounding area, such as leather or wood graining, or stainless steel buffing.

In a still further example, not illustrated, another film layer may be stacked below the leather or plastic matching film 12b. In this film, a lithium ion film or reflective liquid crystal film may be applied to match the desired metallic trim. This film could also have another trim component beneath it which would be revealed when the reflective film is activated. For example, a colored plastic film with a lighting element such as a row of light emitting diodes could be concealed by the reflective film. When the film 12 is activated the colored or lighted area would be revealed. Below this lighted film or lighted area the vehicle radio or climate controls or displays may be provided. The three film 12 layers would provide an overall homogenous appearance to the dashboard and center column. The films could then be electrically activated individually or simultaneously to reveal the underlying display and controls S.

Although many dye molecules are commercially available, multiple dyes may have to be mixed and incorporated into the film 12 to achieve the desired matching color appearance to the surrounding environment area. Alternatively, two or more films 12 of varying color may be stacked on top of one another to achieve a certain appearance. These films may be operated independently to change the concealment device's appearance between multiple colors or finishes and transparency states.

The films 12, 12b may be constructed of a liquid crystal compound and dichroic dye only, having no polymer component and achieving a strongly colored state in the absence of an electric voltage, and a weakly colored state when a voltage is applied. The films 12, 12b may be constructed so as to operate in the reverse mode (i.e., opaque and colored when an electric voltage field is applied, and clear, weakly colored or colorless in the absence of an electric voltage).

The concealment apparatus 10 may also incorporate components to improve its environmental performance. One such example is the use of filters or coatings which reduce the liquid crystal or dye molecules exposure to ultra violet light. The liquid crystal and dye compounds used in such films may degrade over time with exposure to ultra violet light, causing them to fade or lose functionality. The concealment device may incorporate one or more filters, glazings or other substrate layers which have the ability to reduce the amount of ultra violet light from exterior sources such as the sun, or interior sources such as metal halide lamps. One such protective material is Crystalline 40, available from 3M Co., St. Paul, Minn. 55144-1000.

Another environmental factor which may be addressed and improved if desired is the thermal performance of the concealment apparatus 10. The response time of the liquid crystal film is impacted by its temperature. As the environmental temperature within which the film is operating decreases, the response time increases. One method of improving the response time of a liquid crystal film at low temperatures is to increase the voltage of the electrical field applied. At higher drive voltages the liquid crystal molecules will re-orient faster and the response time is improved or decreased. In some instances the response time of the concealment device may be critical. In this instance a temperature sensor such as a thermocouple may be incorporated into the apparatus. The temperature sensor may also be connected to a microcontroller which delivers the electric voltage to the film. As the temperature signal decreases, the voltage applied to the film would increase, thereby reducing and improving the response time of the film 12. The drive circuit may also use thermistors or thermal fuses to change the voltage applied to the film based on the film's temperature.

Additionally the apparatus 10 may be required to operate or be stored in environments whose temperature ranges are outside the normal operating parameters for certain liquid crystal or dye compounds. In this instance, a transparent heater may be incorporated to increase the film's temperature. One such heater is available from Honeywell under the name Elmwood Thermal Sensors Transparent Heater 78000 Series. The heater may be connected to a microcontroller, incorporate thermistors or thermal fuses to control its operation based on the film's temperature.

Additionally a heating element may be incorporated directly into the structure of the films of the concealment apparatus 10. An additional layer of a transparent conductive substance, such as indium tin oxide would be applied to the exterior surface of one of the liquid crystal sheets 14. On top of that external surface layer of indium tin oxide a protective substrate or the above mentioned ultraviolet filter may be applied to protect the indium tin oxide layer from any direct physical contact.

By applying a voltage to this layer of indium tin oxide the electric energy could be converted to heat due to the resistance of the indium tin oxide layer, thereby transferring that heat to the liquid crystal film structure through conduction. This method of construction may be economically preferable, as compared to the addition of a separate heating element which would be comprised of two additional substrate layers surrounding the indium tin oxide layer.

This integrated method may also provide optical transmittance benefits to the concealment device 10 by eliminating at least one of the additional layers of plastic or glass sheet 16 which would be incorporated if a separate transparent heater was applied. Each layer of plastic or glass sheet 16 may cause some reflection of the light which passes through it. By applying the indium tin oxide to the back surface of the liquid crystal film and backing that substrate with a protective layer, the film 12 will have one less layer for light to pass through, and therefore a higher transmission of light. This may be preferable in the instance of visual displays where brightness of the display during operation is important.

It should be understood that operation of the present apparatus 10 makes use of a drive circuit 22, which is schematically illustrated within an electronic housing 40 supporting the display and control system S, in FIGS. 3 and 4, but is likewise provided in connection with each of the embodiments described herein. The drive circuit 22 includes a user interface, which may be touch or voice controlled, having a switch 100 for controlling inputs to a programmable controller. The programmable controller includes a control program operating system that responds to input signals to produce a set of controller outputs. Controller outputs are provided to the drive circuit 22, which is electrically coupled to films 12 at the area 20 to apply a pulse width modulated signal to the film 12 for altering the light transmissive characteristics, or reveal or conceal features, of the film 12.

The controller within the drive circuit 22 may be programmed to conceal or reveal the display or control systems S depending on a variety of electronically detected or physically sensed via sensors, input conditions, for example, whether the vehicle is moving, whether it is dark or light outside, whether the refrigerator door is open, or someone is standing in front of it. These are the signal inputs provided to the controller 104 to product controller outputs which modify apparatus 10 reveal or conceal condition.

In another example a control or display which has a non-uniform surface profile can be concealed using a molded film. For example, if a refrigerator door exterior has a video display installed with a control panel below it, and the control panel is not level with the door (i.e., protruding or sunken in), a single film of polymer stabilized liquid crystal can be made whose surface contour matches that of the entire display or control system. Likewise, as shown in FIG. 7, a non-flat film 12 profile can be provided. These films can be constructed by warm forming the film after the polymer and liquid crystal are applied, or by performing the two sheets of plastic which are used to create the film. In FIG. 7, a cylinder is illustrated, such as an architectural pillar or a support pillar P in a vehicle and the flexible concealment film 12 is embedded to conceal some interior portion of the pillar.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A display or control concealment apparatus comprising:
an electrically activated, switchable film having first and second light transmissive sheets, each light transmissive sheet having a facing surface coated with a transparent conductive material, the first and second light transmissive sheets sealed together by an adhesive material to form a compartment for containing liquid crystal material intermediate the sheets having the surface coated with transparent conductive material;
said electrically activated, switchable film covering a display or control and having a first appearance condition which conceals a display or control when the switchable film is not electrically activated, and electrically activating the film moves the film to a second appearance condition which reveals the display or control covered by the electrically activated, switchable film.

2. The apparatus of claim 1, wherein the transparent conductive material is indium tin oxide.

3. The apparatus of claim 1, wherein the liquid crystal material within the film is a polymer stabilized liquid crystal.

4. The apparatus of claim 1, wherein the liquid crystal material within the film is a polymer stabilized liquid crystal and a dichroic dye material to provide the film with a surface color which is substantially similar to the environment surrounding the display or control covered by the film.

5. A display or control concealment apparatus comprising:
an electrically activated, switchable film having first and second light transmissive sheets, each light transmissive sheet having a facing surface coated with indium tin oxide material, the first and second light transmissive sheets sealed together by an epoxy material to form a compartment for containing polymer stabilized liquid crystal and dichroic dye material intermediate the sheets having the indium tin oxide coated surface;
said electrically activated, switchable film covering a display or control and having a first appearance condition which conceals a display or control by providing a substantially similar surface appearance to the surrounding area when the switchable film is not electrically activated, and electrically activating the film moves the film to a second appearance condition which reveals the display or control covered by the electrically activated, switchable film.

6. The apparatus of claims 1 or 5 having a second electrically activated, switchable film positioned adjacent the electrically activated switchable film, which in combination, provide a substantially similar surface appearance to the surrounding area when the switchable film and second switchable film are not electrically activated, and electrically activating the films moves the films to a substantially transparent appearance condition which reveals the display or control covered by the electrically activated, switchable films.

7. A method of concealing display or controls comprising the steps of:
covering substantially the displays or controls with an electrically activated, switchable film having first and second light transmissive sheets, each light transmissive sheet having a facing surface coated with a transparent conductive material, the first and second light transmissive sheets sealed together by an adhesive material to form a compartment for containing liquid crystal material intermediate the sheets having the surface coated with transparent conductive material;
displaying the displays or controls through the electrically activated switchable film when the film is in a transparent appearance condition during electrical activation of the switchable film; and
concealing the displays or controls behind the electrically activated, switchable film by providing the film with an appearance condition which has a substantially similar surface appearance to the surrounding area when the switchable film is not electrically activated.
